(19) United States
(12) Patent Application Publication
(10) Pub. No.: US 2025/0018335 A1
(43) Pub. Date: Jan. 16, 2025

(54) ELECTRIC VEHICLE EXHAUST SYSTEM

(71) Applicant: FCA US LLC, Auburn Hills, MI (US)

(72) Inventors: Uday Kiran Mahakali, Novi, MI (US); Sreekanth Surapaneni, Oakland, MI (US); Mohan Chagarlamudi, Rochester Hills, MI (US)

(21) Appl. No.: 18/351,743

(22) Filed: Jul. 13, 2023

(51) Int. Cl. B01D 53/78; B01D 53/62; B60L 50/64; B60L 58/26; H01M 10/48; H01M 10/613; H01M 10/625; H01M 10/66; H01M 50/383

(52) U.S. Cl. CPC B01D 53/78; B01D 53/62; B60L 50/64; B60L 58/26; H01M 10/486; H01M 10/613; H01M 10/625; H01M 10/66; H01M 50/383; B01D 2251/304; B01D 2251/306; B01D 2251/604; B01D 2257/108; B01D 2257/502; B01D 2258/0208; B60K 11/04; B60L 2240/545; H01M 2220/20

(57) ABSTRACT

A vehicle including a battery pack including a plurality of battery cells; a pipe in communication with the battery pack, and configured to collect a flow of gases that are generated by the plurality of battery cells; and a battery gas treatment system in communication with the pipe that is configured to treat the flow of gases that are generated by the plurality of battery cells, wherein the battery gas treatment system is configured to treat the flow of gases by at least one of cooling the flow of gases and chemically treating the flow of gases to eliminate or at least reduce a number of various chemical species from the flow of gases.

### FIELD

The present disclosure relates to an electric vehicle exhaust system.

### BACKGROUND

This section provides background information related to the present disclosure which is not necessarily prior art.

Vehicles with electric propulsion systems are becoming increasingly more common. Some electrically propelled vehicles include an electric drive motor at each wheel of the vehicle, and some electrically propelled vehicles include a front electric drive motor for rotating the front wheels of the vehicle and a rear electric drive motor for rotating the rear wheels of the vehicle. In either case, the electric drive motors receive power from a battery pack that includes a plurality of battery cells therein. Example battery cells include lithium-ion battery cells and lithium-metal battery cells.

Lithium-ion and lithium-metal battery cells sometimes undergo a process called thermal runaway during failure conditions. Thermal runaway may result in a rapid increase of battery cell temperature accompanied by the release of various gases, which in some cases may be flammable. These flammable gases may be ignited by the high temperature of the battery, which may result in a fire. Accordingly, in the event of a thermal runaway, it is desirable that the vehicle include features that assist in preventing, or at least substantially minimizing, the ignition of various gases that are generated during the thermal runaway.

### SUMMARY

This section provides a general summary of the disclosure and is not a comprehensive disclosure of its full scope or all of its features.

According to a first aspect of the present disclosure, there is provided a vehicle including a battery pack including a plurality of battery cells; a pipe in communication with the battery pack, and configured to collect a flow of gases that are generated by the plurality of battery cells; and a battery gas treatment system in communication with the pipe that is configured to treat the flow of gases that are generated by the plurality of battery cells, wherein the battery gas treatment system is configured to treat the flow of gases by at least one of cooling the flow of gases and chemically treating the flow of gases to eliminate or at least reduce a number of various chemical species from the flow of gases.

According to the first aspect, the pipe includes a jacket configured for receipt of a cooling fluid that is configured to cool the flow of gases within the pipe.

According to the first aspect, the vehicle further includes a source of the cooling fluid, wherein the source of the cooling fluid is at least one of a vehicle radiator and a container containing a cryogenic cooling fluid.

According to the first aspect, the vehicle further includes a tank configured to store a battery gas treatment fluid and a dosing device in communication with each of the tank and the pipe, wherein the dosing device is configured to inject the battery gas treatment fluid into the flow of gases within the pipe.

According to the first aspect, the vehicle further includes a mixing device located within the pipe at a location downstream from the dosing device.

According to the first aspect, the vehicle further includes a controller in communication with battery gas treatment system and a first temperature sensor, wherein the first temperature sensor is configured to generate a signal indicative of a temperature of the battery pack.

According to the first aspect, after receipt of the signal indicative of the temperature of the battery pack, the controller is configured to instruct the battery gas treatment system to treat the flow of gases.

According to the first aspect, the vehicle further includes a second temperature sensor in communication with the controller and configured to generate a signal indicative of a temperature the flow of gases travelling through the pipe.

According to the first aspect, the vehicle further includes a battery gas conversion device in communication with the pipe and configured to receive the flow of gases.

According to the first aspect, the battery gas conversion device includes a plurality of treatment zones for chemically treating the flow of gases to eliminate or at least reduce the number of various chemical species from the flow of gases.

According to the first aspect, the vehicle further includes a tank configured to store a battery gas treatment fluid and a dosing device in communication with each of the tank and the battery gas conversion device, wherein the dosing device is configured to inject the battery gas treatment fluid into the flow of gases within the battery gas conversion device.

According to a first aspect of the present disclosure, there is provided a vehicle including a battery pack including a plurality of battery cells; a pipe in communication with the battery pack, and configured to collect a flow of gases that are generated by the plurality of battery cells; a battery gas treatment system in communication with the pipe that is configured to treat the flow of gases that are generated by the plurality of battery cells; and a battery gas conversion device in communication with the pipe and configured to receive the flow of gases, wherein the battery gas treatment system is configured to treat the flow of gases by at least one of cooling the flow of gases and chemically treating the flow of gases to eliminate or at least reduce a number of various chemical species from the flow of gases; and wherein the battery gas conversion device includes a plurality of treatment zones for chemically treating the flow of gases to eliminate or at least reduce the number of various chemical species from the flow of gases.

According to the second aspect, the pipe includes a jacket configured for receipt of a cooling fluid that is configured to cool the flow of gases within the pipe.

According to the second aspect, the vehicle also includes a source of the cooling fluid, wherein the source of the cooling fluid is at least one of a vehicle radiator and a container containing a cryogenic cooling fluid.

According to the second aspect, the vehicle also includes a tank configured to store a battery gas treatment fluid, a first dosing device in communication with each of the tank and the pipe, and a second dosing device in communication with each of the tank and the battery gas conversion device, wherein the first dosing device is configured to inject the battery gas treatment fluid into the flow of gases within the pipe and the second dosing device is configured to inject the battery gas treatment fluid into the flow of gases within the battery gas conversion device.

According to the second aspect, the vehicle also includes a mixing device located within the pipe at a location downstream from the first dosing device.

According to the second aspect, the battery gas conversion device includes a plurality of treatment zones for chemically treating the flow of gases to eliminate or at least reduce the number of various chemical species from the flow of gases.

According to the second aspect, the vehicle also includes a controller in communication with battery gas treatment system and a first temperature sensor, wherein the first temperature sensor is configured to generate a signal indicative of a temperature of the battery pack.

According to the second aspect, after receipt of the signal indicative of the temperature of the battery pack, wherein the controller is configured to instruct the battery gas treatment system to treat the flow of gases.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic illustration of an electric or hybrid vehicle including a battery gas treatment system according to a principle of the present disclosure;

FIG. 2 is a schematic illustration of an electric or hybrid vehicle including another battery gas treatment system according to a principle of the present disclosure; and

FIG. 3 is a cross-sectional view of a battery gas treatment chamber according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

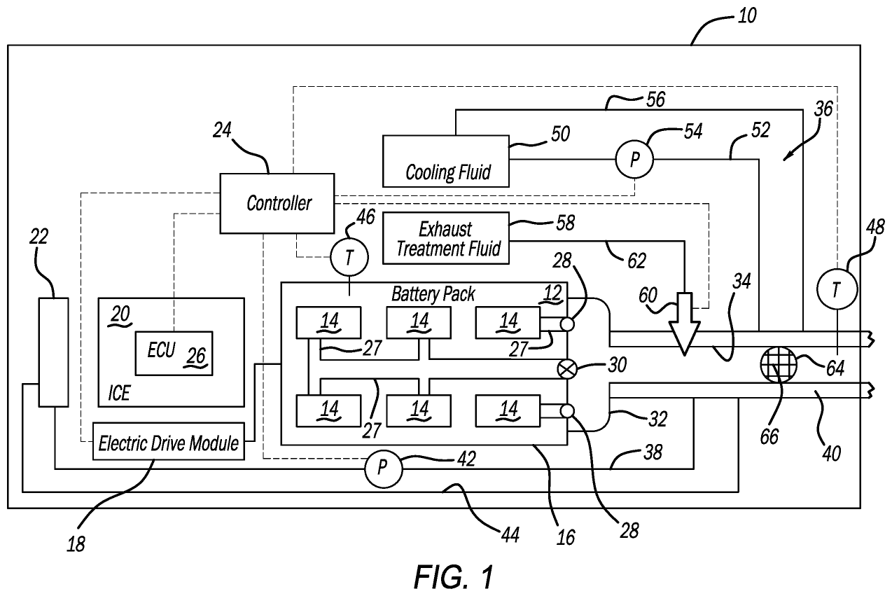

FIG. 1 is a schematic representation of a vehicle 10 according to a principle of the present disclosure. In the illustrated embodiment, vehicle 10 may be an electrically powered vehicle including a battery pack 12 that includes a plurality of battery cells 14. Example battery cells 14 include lithium-ion battery cells, lithium-metal battery cells, and combinations thereof. It should be understood, however, that other types of battery cells 14 known to one skilled in the art may be used, without limitation. Battery pack 12 includes a housing 16 that encases each of the battery cells 14. Housing 16 is preferably formed of a rigid metal material (e.g., steel, aluminum, and the like) that is resistant to puncture and is non-flammable.

Still referring to FIG. 1, an electric drive module 18 is in electrical communication with battery pack 12. Electric drive module 18 may electrically actuate the wheels (not shown) of vehicle 10. While only a single electric drive module 18 is illustrated, it should be understood that vehicle 10 may include a plurality of electric drive modules 18. For example, the front wheels (not shown) of vehicle 10 may be driven by one electric drive module 18, while the rear wheels (not shown) may be driven by another electric drive module 18. Alternatively, each wheel (not shown) may independently be driven by a corresponding electric drive module 12. Regardless of the configuration selected, it should be understood that electric drive module 18 receives a voltage or current from battery pack 12 that is utilized by the electric drive module 18 to drive the wheels of the vehicle 10.

While not required, it should also be understood that vehicle 10 may also include an internal combustion engine (ICE) 20 such that vehicle 10 may be a hybrid electric vehicle. In the event that vehicle 10 is a hybrid electric vehicle including ICE 20, vehicle 10 may also include a heat exchanger or radiator 22 for cooling ICE 20 during operation thereof. Vehicle 10 may include a controller 24 that may communicate with battery pack 12, electric drive module(s) 18, and an electronic control unit (ECU) 26 of ICE 20.

As noted above, battery cells 14 may sometimes undergo a process called thermal runaway during failure conditions of the battery cell(s) 14. Thermal runaway may result in a rapid increase of battery cell temperature accompanied by the release of various gases, which in some cases may be flammable. Example gases that may be released during a thermal runaway event include hydrogen (H₂), carbon monoxide (CO), carbon dioxide (CO₂), and various hydrocarbons including, but not limited to, methane, ethane, ethylene, acetylene, propane, cyclopropane, and butane. As these gases are released and the temperature of battery pack 12 increases, the pressure within battery pack 12 also increases. Housing 16 of battery pack 12, therefore, includes a plurality of vents 28 that permit the pressure and gases to escape housing 16. Vents 28 may each include a valve 30 that may be a one-way valve and opens upon a predetermine pressure threshold being generated within housing 16. For example, if the pressure within housing 16 reaches 100 millibars the valves 30 may open and permit the gases within housing 16 to exit the battery pack 12. Vents 28 may be in communication with various conduits 27, which direct the gases generated during the thermal runaway event to the vents 28 to be expelled from battery pack 12.

While housing 16 may include vents 28 including valves 30 for releasing the gases from battery pack 12, the gases released from battery pack 12 may collect beneath the vehicle 10. If the gases are at a sufficient temperature, the gases may combust after exiting battery pack 12 at a location beneath vehicle 10. If this occurs, there is the potential for other features of the vehicle 10 to also combust including, for example, the tires (not shown) of the vehicle 10, hoses (not shown), vehicle brakes (not shown) and other features. In order to prevent, or at least substantially minimize, the gases from collecting beneath vehicle 10, it should be understood that battery pack 12 may also include a manifold 32 attached to housing 16 of battery pack 12 and in communication with vents 28 that collect the gases that are generated during the thermal runaway event. Manifold 32, in turn, is connected to a pipe 34 that communicates the gases to the atmosphere. Notably, pipe 34 communicates the gases in a direction away from underneath vehicle 10 (e.g., toward a rear of the vehicle) such that pipe 34 is similar to a tailpipe.

When a thermal runaway event occurs, the gases generated during failure of batteries 14 will enter the various conduits 27 and travel in a direction toward vents 28. As the pressure increases in battery pack 12 and reaches the predetermined threshold (e.g., 100 millibars), valves 30 will open and permit the gases to enter and collect in manifold 32 before entering pipe 34 and being directed to the atmosphere at location away from underneath vehicle 10. While it is beneficial to direct the gases away from vehicle 10, it should be understood that the gases generated during the thermal runaway event may still be hazardous to occupants of the vehicle or any person located proximate to vehicle 10 during the thermal runaway event. Accordingly, the present disclosure provides a battery gas treatment system 36 having various components that are configured to treat the gases such that the gases are less hazardous.

Battery gas treatment system 36 is configured to cool the gas flow generated during the thermal runaway event as well as chemically treat the various chemical species present in the gas flow. The gas flow can be cooled in different ways, dependent on the type of vehicle 10. For example, if vehicle 10 is a hybrid electric vehicle including ICE 20 and radiator 22, a first coolant line 38 may direct coolant of radiator 22 to a jacket 40 that surrounds pipe 34. Coolant in first coolant line 38 may be drawn to jacket 40 using a pump 42. After circulating in jacket 40, the coolant may be directed back to radiator 22 using a second coolant line 44. As the gas flow travels through pipe 34, the gas flow will exchange heat with the coolant located in jacket 40 and be cooled.

As illustrated in FIG. 1, pump 42 is in communication with controller 24. Controller 24 is also in communication with a first temperature sensor 46 that generates signals indicative of temperature within battery pack 12 and communicates these signals to controller 24. If first temperature sensor 46 generates a signal indicative of a temperature to controller 24 that indicates a thermal runaway event may be occurring, controller 24 may be configured to instruct pump 42 to begin operation and begin drawing coolant from radiator 22 to jacket 40 to cool the gas flow generated by the thermal runaway event. A second temperature sensor 48, which is also in communication with controller 24, may be located proximate pipe 34 for generating signals indicative of a temperature of the gas flow downstream from cooling jacket 40. If temperatures detected by second temperature sensor 48 are not commensurate with a desired reduction in temperature, controller 24 may instruct pump 42 to increase speed to draw additional coolant to jacket 40 to further lower the temperature of the gas flow in pipe 34. While not illustrated in FIG. 1, it should be understood that various valves that may also be in communication with controller 24 can be located in first and second coolant lines 38, 44 to prevent coolant being directed to jacket 40 when it is not necessary.

While the above description is directed to a vehicle 10 including ICE 20 and radiator 22, it should be understood that even if vehicle 10 does not include ICE 20, vehicle 10 may still include radiator 22 for the purpose of heating/cooling a cabin (not shown) of vehicle 10. Accordingly, even if vehicle 10 does not include ICE 20 (i.e., is not a hybrid vehicle), the above configuration is also equally applicable to vehicles 10 that include battery pack 12 and radiator 22.

Another configuration that can be used to cool the gas flow generated during the thermal runaway event is one that includes a separate source of cooling fluid. As illustrated in FIG. 1, vehicle 10 may include a cooling fluid source 50 that stores a coolant. The coolant may be similar to that used by radiator 22 or may be some other type of coolant such as a cryogenic coolant. Example cryogenic coolants include liquid nitrogen, helium, and argon. Regardless of the coolant stored therein, cooling fluid source 50 provides the coolant to jacket 40 via an inlet line 52 that is drawn by another pump 54 that is communication with controller 24. After circulating through jacket 40, the coolant may return to coolant source 50 via an outlet line 56.

Similar to the above-described cooling system using radiator 22, if first temperature sensor 46 generates a signal indicative of a temperature to controller 24 that indicates a thermal runaway event may be occurring, controller 24 may be configured to instruct pump 54 to begin operation and begin drawing coolant from coolant source 50 to jacket 40 to cool the gas flow generated by the thermal runaway event. If temperatures detected by second temperature sensor 48 are not commensurate with a desired reduction in temperature, controller 24 may instruct pump 54 to increase speed to draw additional coolant to jacket 40 to further lower the temperature of the gas flow in pipe 34. While not illustrated in FIG. 1, it should be understood that various valves that may also be in communication with controller 24 can be located in inlet line 52 and outlet line 56 to prevent coolant being directed to jacket 40 from coolant source 50 when it is not necessary.

As noted above, battery gas treatment system 36 may also include components to chemically treat the various chemical species located in the gas flow generated during the thermal runaway event. In this regard, gas treatment system 36 may include a tank 58 that stores a battery exhaust gas treatment fluid and a dosing device 60 (e.g., injector) that doses the battery exhaust gas treatment fluid into the gas flow located in pipe 34. A connection line 62 communicates the battery exhaust gas treatment fluid stored in tank 58 to dosing device 60.

Dosing device 60 is in communication with controller 24. Upon receipt of a signal from temperature sensor 46 that a thermal runaway event may be occurring, controller 24 can instruct dosing device 60 to begin dosing the battery exhaust gas treatment fluid into the gas flow located in pipe 34. To assist with intermixing of the battery exhaust gas treatment fluid with the battery gases located in pipe 34, pipe 34 may include a mixing device 64. Mixing device 64 may be a static mixing device having a plurality of vanes 66 that are configured to swirl the gas flow and battery exhaust gas treatment fluid as it travels through pipe 34, which results in improved intermixing of the battery gas exhaust gas treatment fluid and the battery gases located in pipe 34.

As the battery exhaust gas treatment fluid intermixes with the battery gases within pipe 34, the battery exhaust gases may be cooled. In this regard, battery exhaust gas treatment fluid is preferably a liquid and as the liquid intermixes with the hot battery gases, the liquid may undergo phase change to gas. In addition, battery exhaust gas treatment fluid may also react with various chemical species of the battery gases and cause the chemical species to either non-hazardous or less hazardous chemical species. Battery exhaust gas treatment fluid may include at least one of water or other liquid that can cool the battery exhaust gases during intermixing and due to evaporation of the battery exhaust treatment fluid, and a liquid that includes chemical species such as KOH (potassium hydroxide), NaOH (sodium hydroxide), and monoethanolamine (MEA) for reacting with the chemical species of the battery gases to reduce the corrosive nature of the battery gases and/or reduce combustibility of the battery gases. For example, battery exhaust gas treatment fluid may include chemical species that oxidize H₂ and CO to H₂O and CO₂, respectively, which are less hazardous (i.e., less combustible, and poisonous, respectively). Preferably, the battery exhaust gas treatment fluid is non-toxic.

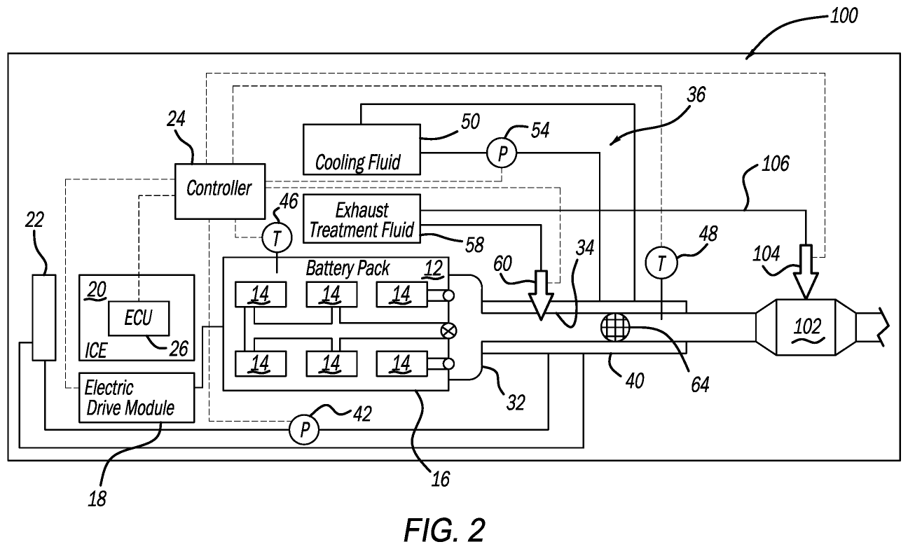

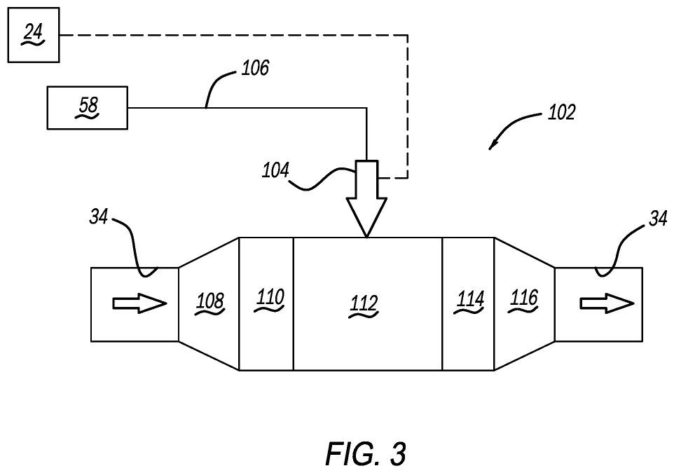

Now referring to FIGS. 2 and 3, another example vehicle 100 is illustrated including battery exhaust gas treatment system 36. Vehicle 100 includes all the features described above relative to vehicle 10 and, as a result, the common features are indicated in FIG. 2 using the same reference numbers. Vehicle 100 differs from vehicle 10 in that battery exhaust gas treatment system 36 further includes a battery exhaust gas conversion device 102 downstream from mixer 64 and a second dosing device 104 configured to provide battery exhaust treatment fluid from tank 58 directly to conversion device 102 via an input line 106, which is best shown in FIG. 3. Similar to dosing device 60, second dosing device 104 is in communication with controller 24 and only operates when controller 24 determines that a thermal runaway event may be occurring based on signals indicative of temperature received from temperature sensor 46.

Now referring to FIG. 3, it can be seen that conversion device 102 includes a casing 103 defining an inlet 105 and an outlet 107 that each communicate with pipe 34. Multiple treatment zones 108, 110, 112, 114, and 116 for treating the various chemical species that may be present in the battery exhaust gas flow are located between inlet 105 and outlet 107. While there are five zones 108-116 illustrated in FIG. 3, it should be understood that conversion device 102 may include a greater or lesser number of zones, as desired. Moreover, it should be understood that the below description of the specific location of each zone 108-116 is not finite and can be adjusted, as desired.

In the illustrated embodiment, first treatment zone 108 may be located proximate inlet 105 and is configured to remove or least reduce hydrogen gas (H₂) from the battery exhaust gas flow. In this regard, first treatment zone 108 may include a plurality of titanium hydride plates that are configured to absorb H₂ from the battery exhaust gas flow. While titanium hydride is a material preferable to absorb the H₂ from the battery exhaust gas flow, it should be understood that other metal hydrides such as magnesium hydride and sodium aluminum hydride may also be used in place of or in addition to titanium hydride.

In the illustrated embodiment, second treatment zone 110 and third treatment zone 112 may be located downstream from first treatment zone 108. It should be understood, however, that each or one of these zones may be located upstream from first treatment zone 108. In any event, second treatment zone 108 and third treatment zone 112 collectively work to remove or at least reduce amounts of CO and CO₂ present in the battery exhaust gas flow.

More particularly, second treatment zone 110 may include beds or grids coated with catalysts such as platinum, palladium, rhodium, or other precious metals that facilitate the conversion of CO to CO₂. Similarly, third treatment zone 112 may include beds or grids coated with catalysts such as nickel, iron, and cobalt that are configured to absorb the CO₂ generated in the second treatment zone 110 as well as generated by batteries 14 during the thermal runaway event. In addition, as shown in FIG. 3, second dosing device 104 doses the battery exhaust gas treatment fluid into third treatment zone 112. Species that may be part of the battery exhaust gas treatment fluid that are effective at reacting with CO that may not be converted into CO₂ in second treatment zone 110 include aqueous NaOH and aqueous KOH, which react with CO to form sodium carbonate (Na₂CO₃) and potassium carbonate (K₂CO₃), respectively.

Fourth treatment zone 114 and fifth treatment zone 116 may include materials that are effective at reacting with methane (CH₄) to remove and or reduce the amount thereof in the battery exhaust gas flow. For example, fourth treatment zone 114 may include beds or grids coated with activated carbon that assist with absorbing the methane. Fifth treatment zone 116 may include grid(s) formed of steel, polymer, ceramic, or glass that help collect droplets of the battery exhaust gas treatment fluid for reaction with the methane. As noted above, the battery exhaust gas treatment fluid may contain MEA, which is effective at absorbing methane.

After passing through conversion device 102, the treated battery exhaust gas flow will exit conversion device and enter pipe 24 to be expelled to the atmosphere. Inasmuch as the battery exhaust gas flow has been cooled and treated to eliminate or at least reduce various chemical species from the battery exhaust gas flow, the treated exhaust gas battery flow will be less hazardous to the environment and less hazardous to any persons that may near vehicle 10 during the thermal runaway event.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle, comprising:
a battery pack including a plurality of battery cells;
a pipe in communication with the battery pack, and configured to collect a flow of gases that are generated by the plurality of battery cells; and
a battery gas treatment system in communication with the pipe that is configured to treat the flow of gases that are generated by the plurality of battery cells,
wherein the battery gas treatment system is configured to treat the flow of gases by at least one of cooling the flow of gases and chemically treating the flow of gases to eliminate or at least reduce a number of various chemical species from the flow of gases.

2. The vehicle according to claim 1, wherein the pipe includes a jacket configured for receipt of a cooling fluid that is configured to cool the flow of gases within the pipe.

3. The vehicle according to claim 2, further comprising a source of the cooling fluid, the source of the cooling fluid being at least one of a vehicle radiator and a container containing a cryogenic cooling fluid.

4. The vehicle according to claim 1, further comprising a tank configured to store a battery gas treatment fluid and a dosing device in communication with each of the tank and the pipe, the dosing device configured to inject the battery gas treatment fluid into the flow of gases within the pipe.

5. The vehicle according to claim 4, further comprising a mixing device located within the pipe at a location downstream from the dosing device.

6. The vehicle according to claim 1, further comprising a controller in communication with battery gas treatment system and a first temperature sensor, the first temperature sensor being configured to generate a signal indicative of a temperature of the battery pack.

7. The vehicle according to claim 1, wherein after receipt of the signal indicative of the temperature of the battery pack, the controller is configured to instruct the battery gas treatment system to treat the flow of gases.

8. The vehicle according to claim 7, further comprising a second temperature sensor in communication with the controller and configured to generate a signal indicative of a temperature the flow of gases travelling through the pipe.

9. The vehicle according to claim 1, further comprising a battery gas conversion device in communication with the pipe and configured to receive the flow of gases.

10. The vehicle according to claim 9, wherein the battery gas conversion device includes a plurality of treatment zones for chemically treating the flow of gases to eliminate or at least reduce the number of various chemical species from the flow of gases.

11. The vehicle according to claim 10, further comprising a tank configured to store a battery gas treatment fluid and a dosing device in communication with each of the tank and the battery gas conversion device, the dosing device configured to inject the battery gas treatment fluid into the flow of gases within the battery gas conversion device.

12. A vehicle, comprising:
a battery pack including a plurality of battery cells;
a pipe in communication with the battery pack, and configured to collect a flow of gases that are generated by the plurality of battery cells;
a battery gas treatment system in communication with the pipe that is configured to treat the flow of gases that are generated by the plurality of battery cells; and
a battery gas conversion device in communication with the pipe and configured to receive the flow of gases,
wherein the battery gas treatment system is configured to treat the flow of gases by at least one of cooling the flow of gases and chemically treating the flow of gases to eliminate or at least reduce a number of various chemical species from the flow of gases; and
wherein the battery gas conversion device includes a plurality of treatment zones for chemically treating the flow of gases to eliminate or at least reduce the number of various chemical species from the flow of gases.

13. The vehicle according to claim 12, wherein the pipe includes a jacket configured for receipt of a cooling fluid that is configured to cool the flow of gases within the pipe.

14. The vehicle according to claim 13, further comprising a source of the cooling fluid, the source of the cooling fluid being at least one of a vehicle radiator and a container containing a cryogenic cooling fluid.

15. The vehicle according to claim 12, further comprising a tank configured to store a battery gas treatment fluid, a first dosing device in communication with each of the tank and the pipe, and a second dosing device in communication with each of the tank and the battery gas conversion device, the first dosing device being configured to inject the battery gas treatment fluid into the flow of gases within the pipe and the second dosing device being configured to inject the battery gas treatment fluid into the flow of gases within the battery gas conversion device.

16. The vehicle according to claim 15, further comprising a mixing device located within the pipe at a location downstream from the first dosing device.

17. The vehicle according to claim 15, wherein the battery gas conversion device includes a plurality of treatment zones for chemically treating the flow of gases to eliminate or at least reduce the number of various chemical species from the flow of gases.

18. The vehicle according to claim 12, further comprising a controller in communication with battery gas treatment system and a first temperature sensor, the first temperature sensor being configured to generate a signal indicative of a temperature of the battery pack.

19. The vehicle according to claim 18, wherein after receipt of the signal indicative of the temperature of the battery pack, the controller is configured to instruct the battery gas treatment system to treat the flow of gases.
